(19) United States
(12) Patent Application Publication
(10) Pub. No.: US 2005/0062431 A1
(43) Pub. Date: Mar. 24, 2005

(54) Plasma etcher

(76) Inventors: Hee-Hwan Choe, Incheon-si (KR); Sung-Chul Kang, Yongin-si (KR); Sang-Gab Kim, Seoul (KR)

Correspondence Address: MCGUIREWOODS, LLP, 1750 TYSONS BLVD, SUITE 1800, MCLEAN, VA, 22102, US

(21) Appl. No.: 10/931,974

(22) Filed: Sep. 2, 2004

(30) Foreign Application Priority Data
Sep. 5, 2003 (KR) 2003-0062204

(51) Int. Cl. H01J 7/24

(52) U.S. Cl. 315/111.21

(57) ABSTRACT

A plasma etcher is provided, which includes: a chamber; top and bottom plasma electrodes provided top and bottom positions of the chamber; a gas injection pipe connected to the chamber; a plurality of diffusion plates provided between the top plasma electrode and the gate injection pipe; and a power generator supplying a plasma voltage to the top and bottom electrodes, wherein the top plasma electrode has a plurality of primary injection holes and the diffusion plates have a plurality of secondary injection holes.

### BACKGROUND OF THE INVENTION

(a) Field of the Invention

The present invention relates to a plasma etcher, and particularly to a plasma etcher used for a manufacturing process of semiconductor devices or liquid crystal displays.

(b) Description of Related Art

In general, a plasma etching process is performed by inflow of a gas into a chamber through a gas injection pipe connected to the plasma etching chamber. A plurality of injection holes are formed in a top electrode arranged to cross the chamber to inject the gas supplied to the top electrode through the gas injection pipe to the entire surface of a glass substrate placed in the chamber.

However, as the size of the glass substrate goes larger, possibility that the gas incoming to the chamber through one gas injection pipe is not injected uniformly becomes larger.

In other words, in case that the gas incoming through the gas injection pipe is incoming into the chamber via the injection hole of the top electrode apart from the gas injection pipe for a specified distance, more of the gas is injected to the center portion of the glass substrate and less to the edge portion because the glass substrate is large. Therefore, the amount and density of the incoming gas is not uniform over the chamber. When a gas mixture is injected to the chamber, velocity of each gas which is included in the gas mixture becomes different, which disturbs uniform gas injection, because each gas in the gas mixture is injected with the same temperature. Thermal velocity of each gas molecule is described as the following equation:
Vth=\sqrt{T/M},
where T is the temperature of the gas molecule and M is the molecular mass.

Therefore, velocity of each gas molecule constituting the gas mixture becomes different due to the difference of molecular mass when the temperature of each gas is equal. If there is difference of mass between gases constituting the gas mixture, velocity of each gas becomes different in horizontal diffusion. Then, the gas mixture is injected with non-uniform distribution.

### SUMMARY OF THE INVENTION

The present invention is directed to provide a plasma etcher which enables uniform injection of gas.

A plasma etcher is provided, which includes: a chamber; top and bottom plasma electrodes provided top and bottom positions of the chamber; a gas injection pipe connected to the chamber; a plurality of diffusion plates provided between the top plasma electrode and the gate injection pipe; and a power generator supplying a plasma voltage to the top and bottom electrodes, wherein the top plasma electrode has a plurality of primary injection holes and the diffusion plates have a plurality of secondary injection holes.

Preferably, the injection holes in the diffusion plates facing each other are alternately arranged.

The plasma etcher may further include a temperature controller provided at the diffusion plates.

The plasma etcher may further include a secondary diffusing plate provided at an inlet of the gate injection pipe.

### BRIEF DESCRIPTION OF THE DRAWINGS

The above and other advantages of the present invention will become more apparent by describing embodiments thereof in detail with reference to the accompanying drawings in which:

FIG. 1 is a schematic diagram of a plasma etcher according to an embodiment of the present invention; and

FIG. 2 is a layout view of a diffusion plate of a plasma etcher according to an embodiment of the present invention.

### DETAILED DESCRIPTION OF EMBODIMENTS

The present invention now will be described more fully hereinafter with reference to the accompanying drawings, in which preferred embodiments of the inventions invention are shown. The present invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Now, a plasma etcher according to an embodiment of the present invention will be described in detail with reference to the accompanying drawings.

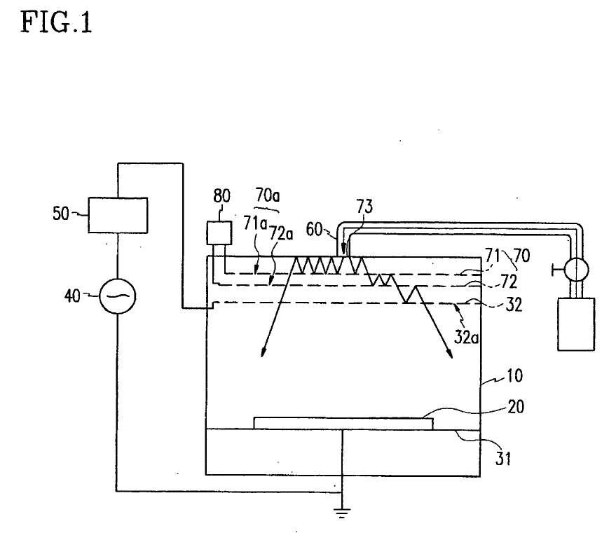

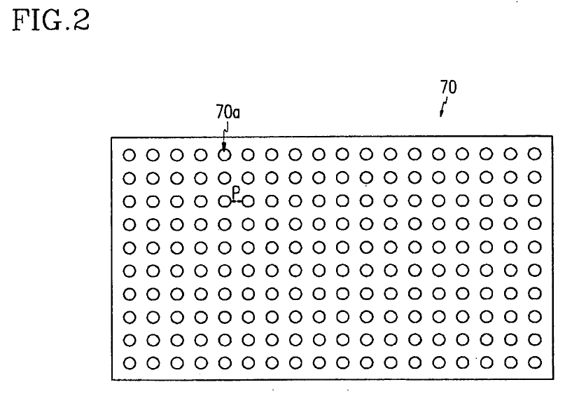

FIG. 1 is a schematic diagram of a plasma etcher according to an embodiment of the present invention, and FIG. 2 is a layout view of a diffusion plate of a plasma etcher according to an embodiment of the present invention.

Referring FIGS. 1 and 2, a plasma etcher according to an embodiment of the present invention includes a chamber 10 in which a plasma process is performed and a supporter 31 in the chamber, on which a glass substrate 20 on which a thin film will be deposited is placed. The supporter 31 also serves as a bottom plasma electrode 31.

A top plasma electrode 32 is arranged in the chamber 32, and a plasma voltage is applied to the top plasma electrode 32 and the bottom plasma electrode 31 from an RF power generator 40. The power generated from the RF power generator 40 is tuned by an impedance matching box 50 and applied into the chamber 10.

A gas injection pipe 60 is connected on the top portion of the chamber 10 of the plasma etcher. A gas mixture is injected through the gas injection pipe 60 into the chamber 10. A plurality of diffusion plates 70 are arranged between the gas injection pipe 60 and the top plasma electrode 32 for uniform diffusion of the injected gas mixture. A plurality of subsidiary injection holes 70a are formed in the diffusion plates 70. It is preferable that diameter of each subsidiary injection hole is 0.2-0.5 mm and distance p between the subsidiary injection holes is about 5 cm.

FIG. 1 shows an embodiment of the present invention which is provided with two diffusion plates. As shown in FIG. 1, subsidiary injection holes 71a and 72a are formed on each of the upper diffusion plate 71 and the lower diffusion plate 72.

The gas mixture injected through the gas injection pipe 60 is supplied to the injection holes 32a of the top plasma electrode via the subsidiary injection holes 71a and 72a of the upper diffusion plate 71 and the lower diffusion plate 72.

Then, a portion of the gas mixture is diffused in horizontal direction by repetitive reflection on the upper diffusion plate 71 and injected to the lower diffusion plate 72 through the subsidiary injection holes 71a, and another portion of the gas mixture passes through the subsidiary injection holes 71a of the upper diffusion plate 71 directly to be injected to the lower diffusion plate 72. A portion of the gas mixture injected to the lower diffusion plate 72 is diffused in horizontal direction by repetitive reflection on the lower diffusion plate 72 and injected to the top plasma electrode 32 through the subsidiary injection holes 72a, and another portion passes through the subsidiary injection holes 72a of the lower diffusion plate 72 directly to be injected to the top plasma electrode 32. A portion of the gas mixture injected to the top plasma electrode 32 is diffused in horizontal direction by repetitive reflection on the top plasma electrode 32 and injected into the chamber 10 through the injection holes 32a, and another portion passes through the injection holes 32a directly to be injected into the chamber 10.

Uniformity of the gas mixture injected into the chamber 10 is improved by horizontal diffusion of the gas mixture.

In other words, the gas mixture passes through the subsidiary injection holes 71a and 72a of a plurality of the diffusion plates and the injection holes 32a of the plasma electrode to be diffused uniformly on the center and edge portions of the chamber.

It is preferable that the upper diffusion plate 71 and the lower diffusion plate 72 are arranged to make the subsidiary injection holes 71a formed in the upper diffusion plate 71 and the subsidiary injection holes 72a formed in the lower diffusion plate 72 to be crossed each other. It is to encourage diffusion of the gas mixture injected through the gas injection pipe 60 to the edge portion of the chamber 10.

The gas mixture can be more diffused in horizontal direction by providing a small diffusion plate 73 at the entrance of the gas injection pipe 60.

On the other hand, it is preferable that the temperature of the gas mixture injected into the chamber is controlled to be constant by maintaining the temperature of the gas mixture passing through the diffusion plates to be constant using a temperature controller 80 arranged on the diffusion plates 71 and 72.

It is to form an uniform thin film on the glass substrate by controlling the temperature of the gas mixture injected into the chamber 10 to be constant in both the chamber in which a plasma etching process is not performed and the chamber in which a plasma etching process has been performed continuously.

The plasma etcher according to the present invention is provided with the diffusion plates having the subsidiary injection holes between the gas injection pipe and the top plasma electrode, which makes the gas mixture injected uniformly into the chamber.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A plasma etcher comprising:
a chamber;
top and bottom plasma electrodes provided top and bottom positions of the chamber;
a gas injection pipe connected to the chamber;
a plurality of diffusion plates provided between the top plasma electrode and the gate injection pipe; and
a power generator supplying a plasma voltage to the top and bottom electrodes,
wherein the top plasma electrode has a plurality of primary injection holes and the diffusion plates have a plurality of secondary injection holes.

2. The plasma etcher of claim 1, wherein the injection holes in the diffusion plates facing each other are alternately arranged.

3. The plasma etcher of claim 2, further comprising a temperature controller provided at the diffusion plates.

4. The plasma etcher of claim 3, further comprising a secondary diffusing plate provided at an inlet of the gate injection pipe.
